(19) United States
(12) Patent Application Publication
(10) Pub. No.: US 2006/0278631 A1
(43) Pub. Date: Dec. 14, 2006

(54) Laminate fabric heater and method of making

(75) Inventors: Kuo-Ting Lee, Guanyin Township (TW); Chien-Hung Lee, Kaohsiung City (TW); Chung-Hua Hu, Taichung City (TW); Chien-Yuan Chen, Hunei Township (TW)

Correspondence Address: JONES DAY, 555 SOUTH FLOWER STREET FIFTIETH FLOOR, LOS ANGELES, CA, 90071, US

(73) Assignee: Challenge Carbon Technology Co., Ltd. of Taiwan

(21) Appl. No.: 11/150,816

(22) Filed: Jun. 10, 2005

(51) Int. Cl. H05B 3/34

(52) U.S. Cl. 219/529; 219/544

(57) ABSTRACT

A laminate fabric heater includes a heating element having a conductive fabric layer patterned to define an electrical circuit having first and second ends and an adhesive layer adhered to a first side of the conductive fabric layer. First and second electrical leads are electrically coupled to the conductive fabric layer at the first and second ends, respectively, and first and second protective layers are disposed on opposing sides of the heating element to form a laminate with the heating element. The heating element is preferably sandwiched between the first and second protective layers so that only the first and second electrical leads extend from the resulting laminate. The first and second ends each preferably include an area of reduced resistivity extending across the width of the electrical circuit and formed from an application of conductive glue. Methods of manufacturing laminate fabric heaters are also provided.

### FIELD

Certain aspects of the present patent document relate to the field of laminate products generally and methods of making laminate products. Other aspects of the present patent document relate to heaters, particularly heaters that employ a resistance heating element and methods of manufacturing such heaters and their elements.

### BACKGROUND

Many types of heaters have been developed using various methods of manufacture. Laminate and film heaters have been made using metal foil, conductive ink, wires and electrically conductive fabrics laminated between two or more protective layers of insulative material.

While heaters manufactured from wire, foil, and conductive ink have been used in industry for some time, laminate fabric heaters are becoming the heater of choice in a number of applications because such heaters tend to be more flexible and have superior weight and heat distribution characteristics. Laminate fabric heaters also tend to be less expensive to manufacture. Foil and printed ink heaters, in particular, are expensive to produce and lack flexibility.

Laminate fabric heaters may be made with woven and non-woven conductive fabrics. Such fabrics typically contain fibers that are electrically conductive such as carbon fibers, metal fibers, or metal coated non-conductive fibers, such as metal coated polyester fibers. Such fabrics may, however, also be made from non-conductive fibers that are dispersed in a resin containing conductive particles, such as carbon black or iron metal particles. Conductive carbon fibers may also be coated with metal to improve their conductivity.

Examples of laminate heaters that employ a carbon fiber fabric heating element are described in Taiwanese Patent No. 0037539 (Taiwan '539 patent), U.S. Pat. No. 6,172,344 ('344 patent), and U.S. Pat. No. 6,483,087 ('087 patent).

The Taiwan '539 patent teaches a carbon fiber fabric heater. In this patent, the carbon fiber fabric heater comprises a rectangular sheet of electrically conductive carbon fiber fabric, wherein two long electrically conductive copper foil strips are attached to two opposing edges of the carbon fiber fabric respectively. An electrical lead wire is attached to each of the copper foil strips and then attached to an in-line switch adapted to control the current passed through the carbon fiber fabric. Interposed in one of the electrical lead wires between its respective copper foil and the switch is a thermostat that is fixed on the surface of the carbon fiber fabric. The carbon fiber fabric and copper foil strips are then laminated between proper plastic films.

The heater disclosed in the Taiwan '539 patent suffers from a number of potential drawbacks. For example, the Taiwan '539 patent does not teach how the copper foil strips are attached to the opposing edges of the carbon fiber fabric. One possibility for attaching the foil strips is by way of mechanical attachment. Another is by way of a conductive contact adhesive, such as the type that is frequently provided on the back of copper foil. In either event, because the carbon fiber fabric will have an uneven surface, the contact resistance between the carbon fiber fabric and conductive copper foil strip will tend to be high. This results not only from the fact that the entire surface of each of the copper foil strips does not come into full contact with the carbon fiber fabric, but also because the copper foil strips have a significantly higher conductivity than the carbon fiber fabric. Due to the limited contact area between the carbon fiber fabric and the copper foil strips, over heating may be observed at the contact points that are created between the copper foil strips and carbon fiber fabric. This situation is made worse during use. As the heater is deformed during use, the copper foil strips will be deformed, further reducing the contact points between the carbon fiber fabric and the copper foil strips and thus increasing the possibility of an over temperature situation. Furthermore, with repeated deformations, it is possible for the copper foil strips to become fatigued and fracture, potentially causing a short situation and sparks.

If adhesive is used as a means of attaching the copper foil in the laminated heater of the Taiwan '539 patent, the adhesive can age over time becoming brittle, thereby losing its adhesive properties and further degrading the current path between the copper foil and carbon fiber fabric. Mechanical attachment on the other hand would typically only be intermittent along the length of the copper foil strips and thus the areas between the attachment points may lose contact with the carbon fiber fabric during use and deformation of the heater.

Because the Taiwan '539 patent teaches that a rectangular heating element should be used so as to cover complete area of the heater, it is difficult to design an electric heating element according to different wattage requirements given a particular size heater. This is because the electrical resistivity of a given carbon fiber fabric is a constant. Thus, if a heating element having a different electrical resistance is required to achieve an electrical heating element with a particular wattage output in a fixed area, the only option available, based on the approach taught in the Taiwan '539 patent, is to select a carbon fiber fabric with a different resistivity, which is not always a practical option and tends to increase the cost of designing heaters for a variety of applications. As a result, the fabric heaters taught in the Taiwan '539 patent have limited flexibility in terms of resistance goals.

Another deficiency of the Taiwan '539 patent is that it fails to teach an adequate method of properly positioning the carbon fiber fabric between the plastic films.

The '344 teaches techniques for making laminate carbon fiber fabric heaters using both a continuous web based process and a batch type process. In both processes, conductive strips of, for example, copper may be applied to opposite edges of the fabric on one or both sides of the fabric. The conductive strips may be applied by a suitable conductive adhesive or bonding composition. Alternatively, the conductive strips may be of the self adhesive type with a conductive adhesive applied to one side thereof. In addition to, or in the alternative to, using a conductive adhesive or bonding composition to attach the conductive strips, the conductive strips may be sewn to the fabric. Once the conductive strips are attached to the fabric, the fabric is encapsulated in or sandwiched between layers of plastic insulating material, such as two layers of thermoplastic. To establish electrical connection with the encapsulated conductor strips, crimp terminals may be crimped through the encapsulation layers into the opposing conductive strips. The '344 patent teaches that a variety of bus bars may be used to make electrical contact with the fabric, including, for example, copper or other electrically conductive metal foil, strip, or woven wire braid.

As with the Taiwan '539 patent, the electrical connection between the conductive foil or strips of the heaters described in the '344 patent and the carbon fiber fabric is prone to problems. Further, because the '344 patent only teaches rectangular carbon fiber fabric heating elements, it is difficult to design heating elements that satisfy both wattage and space requirements for various applications for the reasons noted above. In addition, irregularly shaped heaters are not possible. Finally, the '344 patent does not teach any method for ensuring that the carbon fiber fabric layer is properly positioned between the plastic laminating layers when a batch fabrication process is used.

The '087 patent teaches thermoplastic laminate fabric heaters and methods for making them. Bus bars are attached to opposing edges of a rectangular conductive fabric layer. The conductive fabric layer and bus bars are then sandwiched between two thermoplastic layers. The bus bars can be made of various materials, such as copper, brass or silver foils, and are attached without adhesive to the fabric by riveting the foil to the fabric along its edge. After lamination, the resistance of the heater is increased by making a series of perpendicular cuts through the laminate so that each cut extends through at least one of the bus bars to form a circuit pattern in the form of a zig-zag. By selecting the number of cuts and the width of each strip formed thereby, the resistance of the heating element may be increased over a relatively wide range of values by increasing the electrical path through the heating element. Further, because the cuts are not made through the edge of the thermoplastic layers sandwiching the conductive fabric, the thermoplastic edge essentially frames the circuit and holds the strips of the heating element in place while electrical leads are attached and a second lamination is conducted.

Electrical leads in the form of wires are attached to the copper foil bus bars through the thermoplastic or perforations within the thermoplastic and at locations defining the beginning and the end of the zig-zag pattern. Attachment of the electrical leads may be accomplished by methods such as soldering, brazing, ultrasonic welding, or crimping.

Once the electrical leads are attached, the heater is laminated a second time to hold the heating element strips in place, increase the dielectric strength of the heater, and protect the circuit and wire attachment points. The final encapsulating layers may be additional thermoplastic films or layers of silicone rubber.

The heaters of the '087 patent and the corresponding methods taught therein have various disadvantages. First, although the method the '087 patent teaches a technique for patterning a conductive fabric heating element to increase its resistance, the method taught in the '087 patent for accomplishing this is complicated and expensive in that it requires both sides of the heater to be laminated twice. This may also result in heaters that have a greater thickness than might otherwise be possible if only a single lamination step were required. Second, because the conductive fabric will have an uneven surface, the contact resistance between the conductive fabric and the conductive copper foil strips will tend to be high, particularly between the rivet points. Thus, like the heaters of the Taiwan '539 patent, over temperature is possible through the conduction paths that are created between the copper foil and the fabric in the heaters of the '087 patent. Again, this situation may be made worse during use because as the heater is deformed during use, the copper foil strips will be deformed, further reducing the contact points between the carbon fiber fabric and the copper foil strips and thus increasing the possibility of over temperature situation. With repeated deformations, it is also possible for the copper foil strips to become fatigued and fracture, potentially causing a short situation and sparks. Finally, the technique disclosed in the '087 patent for positioning the conductive fabric within the initial laminate when a batch process is used is cumbersome and time consuming.

In view of the foregoing, a need continues to exist for alternative designs for laminate fabric heaters, heating elements used in such heaters, and methods of making such heaters and heating elements. A need also exists more generally for new laminate products and methods of making such laminate products where the laminate product contains a non-self-supporting layer sandwiched between two protective layers. Accordingly, in one aspect of the present patent document it is an object to provide a new laminate product and method of making the laminate product where the laminate product includes a non-self-supporting layer sandwiched between two protective layers. In another, separate aspect of the present patent document, it is an object to provide new laminate fabric heater that at least ameliorates one or more of the problems noted above with current laminate fabric heaters. In still further aspects of the present patent document, it is an object to provide a new method of making laminate heaters and their corresponding heating elements.

### SUMMARY

Certain aspects of the present patent document relate to laminates and methods of making laminates. Other aspects of the present patent document are directed to conductive fabric heating elements, laminate fabric heaters, and methods of making such heating elements and heaters.

According to one aspect, a new laminate structure is provided. In one embodiment, the laminate structure comprises a patterned layer and first and second protective layers disposed on opposing sides of the patterned layer, wherein the patterned layer is sandwiched between the first and second protective layers. The patterned layer has first and second sides, wherein the first side comprises a patterned non-self-supporting material and the second side comprises an adhesive layer disposed on the non-self-supporting material.

Preferably the first and second protective layers cooperate to encapsulate the patterned layer.

According to another aspect, a method of manufacturing a laminate structure is provided. In one embodiment, the method comprises forming a patterned layer of a non-self-supporting material that is removably disposed on a substrate, applying a first protective layer to a first side of the patterned layer opposite the substrate, removing the substrate, and applying a second protective layer to a second side of the patterned layer, wherein the patterned layer is sandwiched between the first and second protective layers.

According to a further aspect of the present invention, new laminate fabric heaters are provided. In one embodiment, a laminate fabric heater comprises a heating element including a conductive fabric patterned to define an electrical circuit having first and second ends, and an adhesive layer adhered to a first side of the conductive fabric layer. The laminate fabric heater further comprises first and second electrical leads adjacent to and in electrical communication with the conductive fabric layer at the first and second ends, respectively, and first and second protective layers disposed on opposing sides of the heating element to form a laminate with the heating element. The heating element is sandwiched between the first and second protective layers so that the first and second electrical leads extend from the resulting laminate.

In accordance with another embodiment, a laminate fabric heater is provided that comprises a heating element that includes a conductive fabric layer patterned to define an electrical circuit having first and second ends and a non-linear path therebetween, and conductive glue disposed on a first side of the patterned conductive fabric layer at the first and second ends to form areas of reduced resistivity extending across the width of the electrical circuit at the first and second ends. The heater further comprises first and second electrical leads attached to the conductive fabric at the first and second ends, respectively, so that the first and second electrical leads are abutting the conductive glue disposed at the first and second ends, respectively. Further, first and second protective layers are disposed on opposing sides of the heating element to form a laminate with the heating element. The heating element is sandwiched between first so that the first and second electrical leads extend from the laminae.

In each of the forgoing embodiments, the first and second protective layers preferably cooperate to encapsulate the heating element.

The conductive fabrics that may be used in the heaters of the present invention include any conductive fabric (woven or non-woven) that is sufficiently conductive to satisfy the power requirements of a given heater application, and include, by way of example, conductive papers, felts, and cloths. Typical conductive fabrics that may be used in the heaters of the present invention include carbon fiber fabrics, graphite fiber fabrics, metal fabrics (fabrics that include metal coated non-conductive fibers), and metal fiber fabrics (fabrics that include metal fibers). Conductive fabrics made from non-conductive fibers dispersed in a binder containing conductive particles, such as carbon black particles or metal particles, may also be used. For most applications, the selected conductive fabric will preferably have a resistivity of 0.1 ohms per square to 1000 ohms per square, a weight of 5 grams per square meter to 700 grams per square meter, and a thickness of 0.05 millimeter to 5.0 millimeter. More preferably the selected conductive fabric will have a resistivity of 0.1 ohms per square to 100 ohms per square, a weight of 50 grams per square meter to 500 grams per square meter, and a thickness of 0.1 millimeter to 3.0 millimeter.

Carbon fiber fabric is preferably used to form the heating elements of the present invention. More preferably a woven carbon fiber fabric is used. Woven carbon fiber fabrics are preferably woven from spun yarn, but may also be woven from filaments. It should also be noted that if desired, the conductive carbon fibers in the carbon fiber fabric may optionally be coated with metal to improve their conductivity and adjust the resistivity of the carbon fiber fabric.

The first and second protective layers may be formed from a thermoplastic, such as nylon, polyurethane, polyvinychloride, and polyester. Preferably, however, the protective layers comprise a laminate of a binding layer and one or more finishing layers. The binding layer may comprise, for example, a thermoplastic, including any of the foregoing thermoplastics, a hot melt adhesive, or compound containing both a thermoplastic material and a hot melt adhesive.

A wide variety of materials may be used for finishing material depending on the final application of the laminate heater. Potential finishing materials that may be used include layers of a natural or synthetic fabric, foam, rubber, plastic sheets, fiberglass, wood, and metal. Synthetic fabrics and plastic sheet products may be made from a variety of plastics resins, including polyurethane, polyvinylchloride, ABS, PC, polyester, polyamide, and polyolefines. Thus, the finishing layer may also comprise a thermoplastic that melts or has a softening temperature at a higher temperature than the binding material.

A particularly preferred material for the protective layers comprises a laminate of hot melt adhesive, thermoplastic sheet, and polyester fabric.

According to another aspect of the present invention, methods of manufacturing laminate fabric heaters are provided. One method according to the invention comprises the steps of forming a fabric heating element that is removably disposed on release paper, attaching first and second electrical leads to the fabric heating element; applying a first protective layer to a first side of the heating element, removing the release paper, and applying a second protective layer to the other side of the heating element. The heating element is sandwiched between the first and second protective layers so that electrical leads associated with the heating element extend from the resulting laminate. Preferably the first and second layers cooperate to encapsulate the heating element.

The fabric heating element is preferably formed by a method including the steps of (i) obtaining a laminate comprising a conductive fabric having a first side and a second side opposite the first and a substrate that is removably laminated to the second side of the conductive fabric, and (ii) patterning the conductive fabric to produce an electrical circuit having first and second ends while leaving the release paper intact.

According to another embodiment, a method of manufacturing a laminated fabric heater comprises the steps of forming a fabric heating element, attaching first and second electrical leads the heating element, applying a first protective layer to one side of the heating element, and applying a second protective layer to a second side of the heating element. The heating element is sandwiched between the first and second protective layers so that first and second electrical leads for the heating element extend from the resulting laminate. The heating element of the present embodiment is preferably formed by a method including the steps of (i) patterning a conductive fabric to produce an electrical circuit having first and second ends and a non-linear path therebetween, and (ii) applying conductive glue on a first side of the patterned conductive fabric at the first and second ends to form areas of reduced resistivity extending across the width of the electrical circuit at the first and second ends. Further, in the present embodiment, the first and second electrical leads are attached to the conductive fabric to the patterned conductive fabric so that the first and second electrical leads are abutting the conductive glue disposed at the first and second ends, respectively.

Further aspects, objects, desirable features, and advantages of the invention will be better understood from the detailed description and drawings that follow in which various embodiments of the disclosed invention are illustrated by way of example. It is to be expressly understood, however, that the drawings are for the purpose of illustration only and are not intended as a definition of the limits of the invention.

### BRIEF DESCRIPTION OF THE DRAWINGS

FIG. 1 is an example of laminate fabric heater according to one embodiment of the present invention.

FIG. 2 is an enlarged cross-sectional view along line 2-2 shown in FIG. 1.

FIG. 3 is an exploded cross-sectional view of the laminate fabric heater of FIG. 1 taken along line 2-2.

FIG. 4 is a top plan view of one embodiment of a patterned conductive fabric heating element removably disposed on a substrate in accordance with another aspect of the present invention.

FIG. 5 is a top plan view of another embodiment of a patterned conductive fabric heating element removably disposed on a substrate.

FIG. 6 is a flow chart illustrating the steps for manufacturing a laminate conductive fabric heater according to one embodiment of the present invention.

FIG. 7 is a flow chart illustrating the steps for forming a fabric heating element according to one embodiment.

FIG. 8 is a flow chart illustrating the steps for manufacturing a laminate conductive fabric heater according to another embodiment of the present invention.

FIG. 9 is a flow chart illustrating the steps for forming a fabric heating element according to another embodiment.

### DETAILED DESCRIPTION

The preferred embodiments will now be described with reference to the drawings. To facilitate description, reference numerals designating an element in one figure will represent the same element in any other figure.

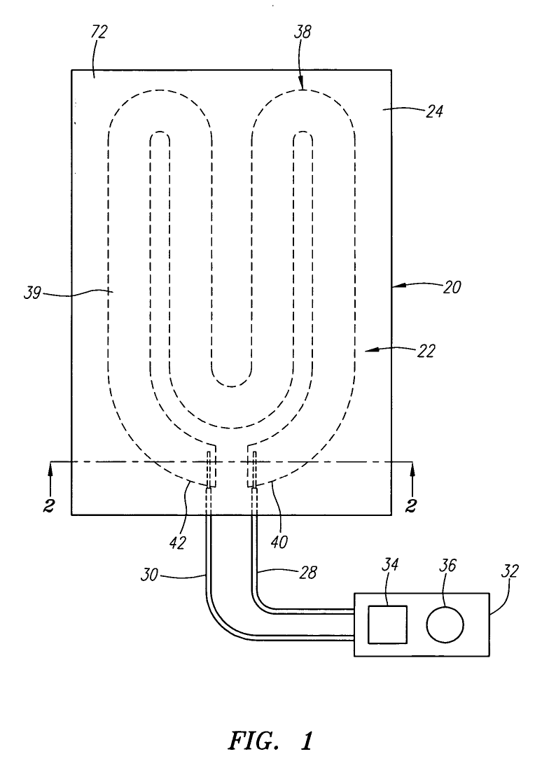

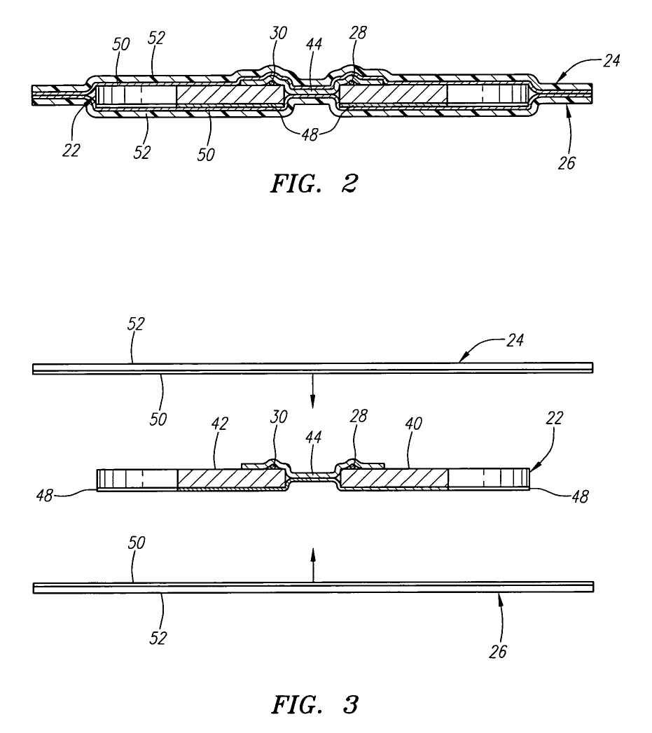

Referring to FIG. 1, an example of a laminate fabric heater 20 according to the present invention is illustrated. Laminate fabric heater 20 includes a fabric heating element 22 and, as best seen in FIGS. 2 and 3, first and second protective layers 24 and 26. Laminate fabric heater 22 also includes first and second electrical leads 28, 30, which are adjacent to and in electrical communication with heating element 22 at first and second ends 40, 42, respectively. Heating element 22 is preferably sandwiched between the first and second protective layers so that only electrical leads 28, 30 extend through the edge of the laminate structure. More preferably, first and second protective layers 24, 26 cooperate to encapsulate heating element 22, and thereby render the laminate heater 20 waterproof.

The operation of laminate fabric heater 20 is preferably controlled by a controller 32, which in the present embodiment includes a display 34 and a temperature adjustment means 36. The controller 32 may include a battery source of power (disposable or rechargeable) for powering the laminate fabric heater 20. Alternatively, controller 32 may be adapted to be connected to an external power source, such as a wall outlet, through a power cord to power heater 20.

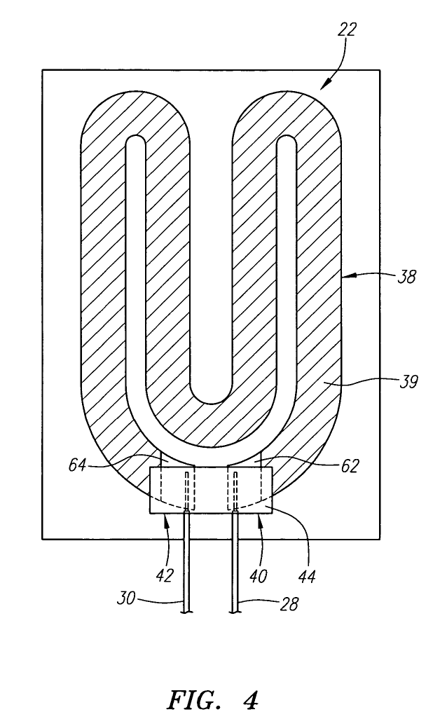

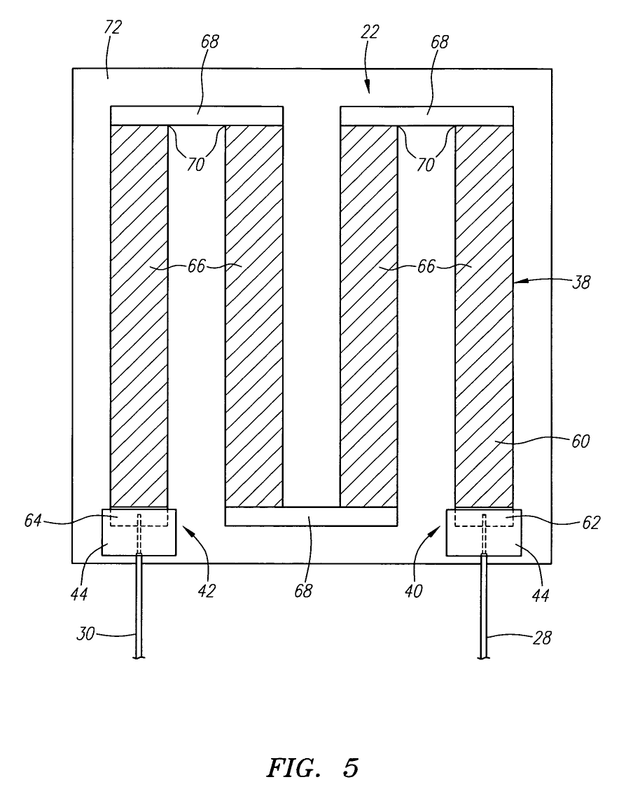

Fabric heating element 22 comprises an electrical circuit 38 having a first end 40 and a second end 42 and is formed from a patterned conductive fabric layer. The patterned conductive fabric layer, and hence the electrical circuit 38, may be patterned to have a wide variety of shapes and sizes. For example, in FIG. 4, heating element 22 is shown to comprise a patterned conductive fabric layer 39 that has been patterned to have a serpentine shape between the first and second ends, 40, 42. By contrast, in FIG. 5 a fabric heating element 22 is shown to comprise a patterned conductive fabric layer 60 that has been patterned to have a zig-zag shape between the first and second ends 40, 42 of the electrical circuit 38.

As shown in FIGS. 1-5, electrical leads 28, 30 are positioned adjacent to and in electrical communication with a first side of the patterned conductive fabric 39, 60 at the first and second ends 40, 42. One or more tape strips 44 may be used to position the electrical leads and attach them to the heating element 22 until the heating element 22 is ultimately sandwiched between the first and second protective layers 24, 26. In such embodiments, the one or more tape strips 44 will be laminated into the heater 20 as shown in FIGS. 2 and 3. Preferably the tape strip(s) 44 comprise a double-sided adhesive or a hot melt adhesive to help ensure that following lamination heater 22 will exhibit and maintain good lamination qualities in the region of the tape strip(s) 44 over the life expectancy of the heater.

As best seen in FIG. 2, in some embodiments, fabric heating element 22 further comprises a thin adhesive layer 48 adhered to one side of the patterned conductive fabric layer. Preferably adhesive layer 48 comprises a double sided adhesive. As will be explained in more detail below, adhesive layer 48 is also an artifact of a preferred fabrication technique for the heating elements 22 and laminate heaters of the present invention.

Preferably heating element 22 also includes regions 62, 64 of reduced resistivity at the first and second ends 40, 42. Regions 62, 64 may be generated by applying, for example, a conductive glue to the indicated regions. The viscosity of the conductive glue is preferably sufficiently low to permit the glue to at least partially penetrate into the conductive fabric to help reduce the contact resistance of the fabric heating element 22 at the application points. The conductive glue also smoothes out the surface of the conductive fabric. As a result, conductive glue provides an effective means of increasing the contact area between lead wires 28, 30 and the fabric heating element 22. In addition, the conductive glue provides a reliable electrical connection, and by applying the conductive glue across the entire width of the heating element 22 at the first and second ends, the conductive glue also performs the same function as the copper bus bars that have traditionally been used in laminate heaters, but without the attendant disadvantages associated with the metal or copper bus bars traditionally used. In preferred embodiments of the laminate heaters according to the present invention, therefore, metal bus bars are omitted between the lead wires 28, 30 and the fabric heating element 22. In other words, preferably the lead wires 28, 30 are attached to the conductive fabric layer at the first and second ends 40, 42, respectively, so that the first and second electrical leads are abutting the conductive glue disposed at the first and second ends. In other embodiments, however, copper foil bus bar may be interposed between the electrical lead wires and the regions 62, 64 of reduced resistivity.

The conductive glue may be applied to regions 62, 64 using a variety of techniques, including, for example, painting, spreading, and spraying.

The conductive fabrics that may be used for the patterned conductive fabric layer 39 or 60 include any conductive fabric (woven or non-woven) that is sufficiently conductive to satisfy the power requirements of a given heater application. Typical conductive fabrics that may be used in the heaters of the present invention include carbon fiber fabrics, graphite fiber fabrics, metal fabrics (fabrics that include metal coated non-conductive fibers), and metal fiber fabrics (fabrics that include metal fibers). Conductive fabrics made from non-conductive fibers dispersed in a binder containing conductive particles, such as carbon black particles or metal particles, may also be used. For most applications, the selected conductive fabric will preferably have a resistivity of 0.1 ohms per square to 1000 ohms per square, a weight of 5 grams per square meter to 700 grams per square meter, and a thickness of 0.05 millimeter to 5.0 millimeter. More preferably the selected conductive fabric will have a resistivity of 0.1 ohms per square to 100 ohms per square, a weight of 50 grams per square meter to 500 grams per square meter, and a thickness of 0.1 millimeter to 3.0 millimeter.

Carbon fiber fabric is preferably used to form the heating element 22 of the present invention. More preferably a woven carbon fiber fabric is used to form the heating element. If a woven carbon fiber fabric is used, preferably the fabric is woven from spun yarn. However, fabrics woven from, for example, tows of continuous filaments may also be used. It is also desirable to carbonize the carbon fiber fabric after weaving rather than prior to weaving.

Carbon fiber fabrics woven from spun yarn are preferred because they tend to be smoother and more flexible than carbon fiber fabrics formed by other techniques, such as being woven from tows that comprise continuous carbon filaments. Further, because the typical staple length in yarns spun from carbon fiber filaments is generally in the range of one to two inches, each filament in a spun yarn tends to contact the surface of the yarn. As a result, the conductive glue applied at regions 62, 64 to form the electrodes will tend to contact a greater number of filaments and the conduction path of those filaments will be throughout the cross-section of the yarn, which should result in reduced contact resistance between the fabric heating element 22 and electrical leads 28, 30.

One suitable woven carbon fiber fabric that may be used in the present invention is disclosed in U.S. Pat. No. 6,172,344, which is hereby incorporated by reference. The carbon fiber fabric disclosed in the '344 patent is made from polyacrylonitrile based fibers and is carbonized after being woven. The method described in U.S. Pat. No. 6,156,287, which is hereby incorporated by reference, may be modified to make suitable carbon fiber fabrics for use in the present invention. In particular, instead of activating the PAN-based oxidized fabrics in a moisturized carbon dioxide gas as taught in the '287 patent, the oxidized PAN-based fabric may simply be carbonized by heating in an argon or nitrogen atmosphere for the corresponding period of time that that the activation process would be carried out.

If desired, some portion of the conductive carbon fibers in the carbon fiber fabric may be coated with metal to improve their conductivity and adjust the resistivity of the carbon fiber fabric.

The conductive fabric is preferably made from a carbon fiber fabric because carbon fiber fabrics possess numerous desirable characteristics. For example, they are capable of providing uniform heating across their surface. Further, many types of carbon fiber fabrics can be safely folded and bent into various shapes and still reliably act as a resistance heater without sparking or losing its conductivity. Many carbon fiber fabrics are also soft and flexible, as well as durable and washable. Carbon fiber fabrics also do not consume oxygen and are therefore safe for indoor use. Finally, carbon fiber fabrics are extremely efficient in far infra-red irradiation transformation for health care applications.

While the patterned conductive fabric layers 39, 60 shown in FIGS. 4, 5 have a non-linear electrical path between the first and second ends 40, 42 of the circuit 38, the laminate heaters of the present invention are not so limited. For example, in some embodiments, it may be desirable to employ patterned conductive fabric layers that are patterned to have a simple rectangular shape between the first and second ends. Essentially, for each particular heater 20, the heating element 22 will need to be formed from a patterned conductive fabric layer that is shaped based on the conductive fabric used to meet the electrical requirements of the heater in terms of resistance and power consumption and the physical requirements of the heater in terms of size and shape. However, because the heating element 22 may comprise a patterned conductive fabric layer of essentially any desired shape, designing heating elements that will satisfy the electrical and physical requirements of a wide variety of applications is straight forward.

FIG. 4 shows a heating element 22 comprising a patterned conductive fabric layer 39 having a serpentine shape between its first and second ends 40, 42. The shape and size of the patterned carbon fiber fabric layer 39 determines the length of the carbon fiber fabric circuit through which electrical current will flow, thereby determining power consumption and heat characteristics. Thus, the patterned conductive fabric layer 39 is preferably shaped to provide desired electrical characteristics, such as resistance and power output characteristics required for a particular application. Conductive fabric layer 39 is also preferably shaped to meet shape limitations of the laminate fabric heater 20.

FIG. 5 shows an alternative embodiment of a patterned carbon fiber fabric layer 60 that has been patterned to have a zig-zag shape between the first and second ends 40, 42. The zig-zag shape will typically include two or more parallel strips 66 of conductive fabric. Further, each pair of strips 66 are attached at one end by a bridging portion of conductive fabric. As seen from FIG. 5, the bridging portion moves from one edge to the other edge of the of the heating element 22 with each successive pair of strips 66, thus providing the zig-zag shape.

Regions 68 of reduced resistivity are preferably provided at each of the connected ends of the strips 66. Regions 68 are formed through the application of conductive glue to the conductive fabric in the regions 68. As shown in FIG. 5, preferably the conductive glue is applied so that the regions 68 span the entire width of the patterned conductive fabric at each of the attached ends and further encompass all of bridging portion of the conductive fabric. The application of conductive glue in regions 68 allows for uniform current flow through the carbon fiber fabric heating element in these regions because current can flow through the conductive glue in the connecting regions easily. The application of conductive glue in regions 68 thus eliminates high current densities in the corners 70 which could otherwise over heat the fabric heating element 22. As a result, application of the conductive glue also eliminates the need for metal bus bars in regions 68.

While copper or other metal bus bars are not required in regions 68, and are preferably not included in regions 68, the present invention does not exclude their use, unless specifically stated, in addition to the conductive glue that is applied to regions 68. Further, although less desirable, it should be recognized that in some embodiments traditional metal bus bars (e.g., copper foil strips) may be substituted for the conductive glue in regions 68, as well as regions 62 and 64.

As seen in FIGS. 4 and 5, the patterned carbon fiber fabric layers 39 and 60 are supported by a substrate 72 after being patterned to the desired shape. The patterned conductive fabric layers 39 and 60 are actually removably laminated to the substrate 72 by adhesive layer 48. This is advantageous because many of the conductive fabrics that may be used in the heaters of the present invention are soft and flexible such that they are non-self-supporting. In other words, the fabric is not capable of supporting itself and collapses or folds when only supported from one end, particularly once patterned. As a result, such fabrics are difficult to work with, particularly in the lamination processes that may be used to fabricate the heaters of the present invention.

Substrate 72 helps maintain the fabric heating element 22 in its desired shape during the manufacturing processes, including application of the conductive glue to regions 62, 64 and 68, attachment of lead wires 28 and 30 with tape 44, and subsequent application of the first protective layer 24. Substrate 72 may also be used to facilitate alignment of the protective layer with the desired positioning of the heating element 22 if a lamination process is used. This may be accomplished, for example, by using a substrate 72 that matches the shape of the first protective layer 24 or some portion thereof. As a result, when the substrate 72 is lined up with the first protective layer 24, or some corresponding feature thereof, heating element 22 will be properly positioned vis a vis the first protective layer for lamination.

Substrate 72 preferably comprises a release paper of suitable weight to support the heating element throughout the manufacturing process. In addition, the release paper should have sufficient heat resistance that it does not degrade during the lamination process described below.

One suitable release paper comprises a paper substrate laminated with a PE film. More preferably, the release paper comprises a paper substrate laminated with a PE film on each side so as to form a double side PE laminated paper.

Adhesive layer 48 which removably bonds the conductive fabric to the release paper is preferably a double-sided acrylic or silicon based adhesive. The double-sided adhesive may be with-substrate or without-substrate. Preferably, the adhesive 48 does not have a substrate. Where a double sided adhesive having a substrate is employed, typically the substrate will be cotton or PET.

As noted above, the heating element 22 is laminated between first and second protective layers 24, 26 so that preferably the heating element is encapsulated between the protective layers and only the electrical leads 28, 30 extend from the laminate fabric heater 22. Preferably the heating element is sufficiently encapsulated between the protective layers so that the heater is waterproof.

The first and second protective layers 24, 26 may be formed from unsupported sheets or hot coatings of a thermoplastic, such as nylon, polyurethane, polyvinychloride, and polyester. Preferably, however, the protective layers comprise a laminate of a binding layer 50 and one or more finishing layers 52. The binding layer 50 may comprise, for example, a thermoplastic, including any of the foregoing thermoplastics or a hot melt adhesive.

A wide variety of materials may be used for finishing layers 52 depending on the final application of the laminate heater. Potential finishing materials that may be used include layers of a natural or synthetic fabric, foam, rubber, plastic sheets, fiberglass, wood, and metal. Synthetic fabrics and plastic sheet products may be made from a variety of plastics resins, including polyurethane, polyvinylchloride, ABS, PC, polyester, polyamide, and polyolefines. Thus, the finishing layer 52 may also comprise a thermoplastic. However, the finishing layer 52 should have a higher melting temperature or glass transition temperature than that of the material used as the binding layer.

A particularly preferred material for protective layers 24, 26 comprises a laminate having a binding layer 50 comprising a hot melt adhesive and a first finishing layer 52 immediately adjacent the holt melt adhesive comprised of a thermoplastic, more preferably a polyurethane thermoplastic, and a second finishing material 52 adjacent the thermoplastic comprised of a polyester fabric.

The present invention provides for an extremely cost effective and efficient method of manufacturing laminate products, particularly laminate fabric heater, which have a myriad of commercial applications, but also laminate products in general.

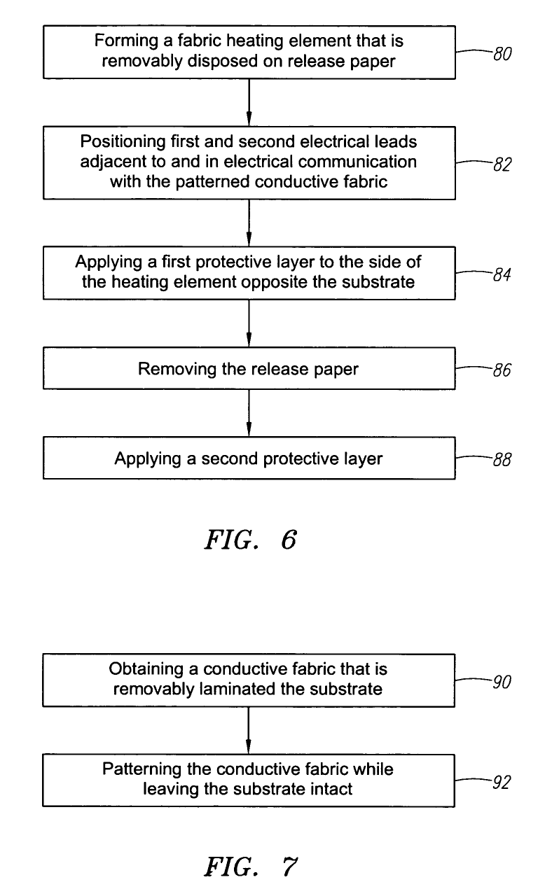

FIG. 6 is a flow chart illustrating the basic manufacturing steps for manufacturing a laminate heater according to one embodiment of the present invention. In step 80, a fabric heating element 22 that is removably disposed on a substrate 72 is formed. In step 82, first and second electrical leads 28, 30 are attached to the fabric heating element 22. In step 84, a first protective layer 24 is applied to a first side of the fabric heating element 22. In step 86, the substrate 72 is removed. Finally, in step 88 a second protective layer 26 is applied to a second, opposite side of the heating element. As a result of the foregoing steps, the heating element 22 is sandwiched between the first and second protective layers 24, 26 so that the first and second electrical leads 28, 30 extend from the resulting laminate. Preferably, the first and second protective layers are applied in a manner so as to encapsulate the heating element 22.

FIG. 7 illustrates one embodiment of a method for forming a fabric heating element 22 according to the present invention and which may be used as step 80 in the method illustrated in FIG. 6. According to the method shown in FIG. 7, in step 90, a laminate comprising a conductive fabric and a substrate in which the conductive fabric is removably laminated to a surface of the substrate is obtained. Then, in step 92 the conductive fabric is patterned to produce a patterned conductive fabric layer, such as layer 39 or 60, comprising an electrical circuit 38 having first and second ends 40, 42 while leaving the substrate 72 intact.

A laminate of a conductive fabric that is removably laminated to a substrate may be obtained, for example, by laminating a PE coated release paper, preferably a double side PE laminated paper, to a suitable conductive fabric with a double sided pressure sensitive adhesive using standard lamination techniques. Preferably, an entire roll of the desired conductive fabric is laminated at one time to the release paper using a suitable double sided adhesive. In this way, portions of the roll may be cut or sliced from the larger roll on an as needed basis, and the remainder stored for future use. For example, if the width of the typical heater 22 manufactured is less than that of the entire roll, it is possible to slit the larger roll into a series of narrower rolls from which a desired length of the laminate may be cut to form a heating element 22 for a particular heater 20.

Although it is more economical to work with large rolls of a suitable conductive fabric, the present invention also contemplates that individual sheets of the conductive fabric may be laminated with the release paper.

In step 92, the conductive fabric is patterned to give the desired power and shape requirements for the laminate heater being fabricated. Patterning is preferably carried out using a punch press. The parameters of the press should be set so that following the punching process, the conductive fabric will be cut, but the laminated substrate 72 will remain intact. As a result, when the excess conductive fabric is removed from the substrate, a patterned conductive fabric layer, such as layer 39 or layer 60, will remain on the substrate 72 as shown in FIGS. 4 and 5.

As noted above, substrate 72 may also be used to facilitate proper positioning or alignment of heating element 22 with respect to the protective layers 24, 26. In other words, substrate 72 may be used to facilitate the proper positioning of heating element 22 within heater 20. This may be accomplished, for example, by cutting or patterning the conductive fabric/substrate laminate prior to step 92 so that the resulting perimeter of the laminate matches the exterior shape of protective layer 24 or some portion thereof. As a result, once the conductive fabric is patterned in step 92, the outer perimeter of the substrate 72 will continue to match that of the protective layer 24 or some relevant portion thereof. Thus, once the substrate 72 is aligned with the protective layer 24 prior to lamination, proper alignment of the heating element within the final heater 22 will be assured.

Although not required in the method illustrated in FIG. 7, following step 92 conductive glue is preferably applied at the first and second ends 40, 42 to form regions 62, 64 for the reasons described above. If the patterned conductive fabric layer includes sharp corners, such as the zig-zag pattern shown of the patterned conductive fabric layer 60 of FIG. 5, then conductive glue may also be advantageously applied to additional regions 68 to reduce the resistivity of the conductive fabric in areas that would potentially result in charge concentration and overheating in the conductive fabric.

Once fabric heating element 22 is formed, first and second electrical leads 28, 30 are positioned so that they are adjacent to and in electrical communication with the patterned conductive fabric layer at the first and second ends 40, 42. Preferably, first and second leads are directly abutting regions of reduced resistivity formed by the application of conductive glue as noted above. However, in other embodiments, bus bars formed of metal foils may be used.

Stripped portions of electrical leads 28, 30 are attached to the two ends of the patterned carbon fiber fabric by one or more tape strips 44 of a double-sided adhesive tape or hot melt adhesive tape. Preferably only that portion of the electrical leads 28, 30 that will be in electrical contact with the heating element 22 are stripped so that the first and second protective layers may be bonded to the insulation jacket of the electrical leads. Tape strip(s) 44 may be used to position the electrical leads 28, 30 and attach them to the heating element 22 until the heating element may be sandwiched between the first and second protective layers.

In step 84, preferably the protective layer 24 is applied to the heating element by a lamination process or similar technique. In the preferred embodiment, protective layer 24 is laminated to a first side of the heating element 22, opposite the substrate 72, by use of a hot press. In other embodiments, however, protective layer may be laminated to the heating element 22 by one or more of the following processes: IR heating, hot plate welding, hot roll press welding, thermal stacking, ultrasonic sealing, and high frequency sealing.

Prior to lamination with the heating element 22, protective layer 24 is preferably aligned with the release paper so that the heating element is properly positioned relative to the protective layer 24. This will also subsequently ensure the proper alignment of the heating element when the second protective layer 26 is applied. The cutting of the substrate 72 or release paper so that it matches the outline of the first protective layer 24 allows for great precision, with little effort during manufacturing, in placement of the heating element 22 at a desired location within the final laminate heater 20.

After laminating the first protective layer, the release element is stripped in step 86 and then in step 88 the second protective layer 26 is applied to the opposite side of the heating element 22 so that the heating element 22 is sandwiched between the first and second protective layers 24, 26. The same lamination process used to laminate the first protective layer may be used to laminate the second protective layer, or an alternative lamination process may be used. It should also be recognized that the first and/or second protective layers may also be applied by the application of liquid coating materials that subsequently set firm naturally or by application of heat. Thus, for example, liquid or semi-liquid thermoplastic materials may be hot coated onto the heating element and then cooled to form the protective layers.

Preferably the first and second protective layers cooperate to encapsulate the heating element 22 so as to provide a water-tight sealing around the patterned conductive fabric layer, conductive glue, and the electrical leads and their connections.

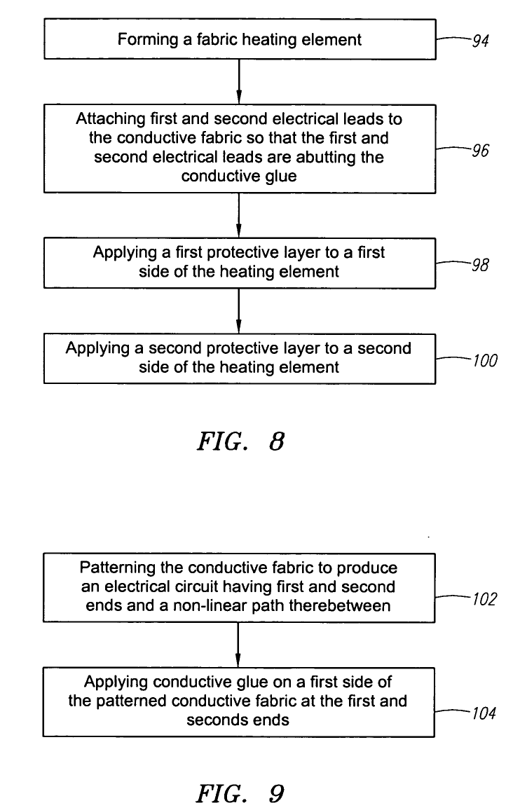

An alternative method for making laminate heaters 20 according to the present invention is illustrated in FIGS. 8 and 9. In step 94, a fabric heating element 22 is formed. Fabric heating element 22 is formed according to the process shown in FIG. 9. In particular, in step 102, the conductive fabric is patterned to produce an electrical circuit 38 having first and second ends 40, 42 and a non-linear path therebetween. Then in step 104, conductive glue is applied on a first side of the patterned conductive fabric at the first and second ends 40, 42 to form areas 62, 64 of reduced conductivity extending across the width of the electrical circuit at the first and second ends. Thus, one distinction between the method of FIG. 8 and the method of FIG. 6 is that in the method of FIG. 8 the patterned conductive fabric layer is not required to be laminated to a substrate. On the other hand, the method of FIGS. 8 and 9 does require that conductive glue be applied to form regions 62, 64.

Although the method set forth in FIGS. 8 and 9 does not require the patterned conductive fabric layer to be laminated on a substrate, preferably it is for the reasons discussed above.

In addition to applying conductive glue to form regions 62, 64, if desired conductive glue may be applied to one or more regions between the first and second ends 40, 42 to produce regions of reduced conductivity, such as regions 68 shown in FIG. 5.

After the fabric heating element 22 is formed in step 94, in step 96 first and second electrical leads 28, 30 are attached to the patterned conductive fabric layer so that the first and second electrical leads 28, 30 are abutting the conductive glue disposed at the first and second ends 40, 42, respectively. Thus, in the present embodiment, no metal bus bar is interposed between the electrical leads and the patterned conductive fabric layer.

In step 98, a first protective layer is applied to a first side of the heating element 22 as described above. Then in step 100 a second protective layer is applied to a second side of the heating element. As a result the heating element is sandwiched between the first and second protective layers 24, 26 so that the first and second electrical leads 28, 30 extend from the resulting laminate. Preferably the first and second protective layers cooperate to encapsulate and water proof the heating element, conductive glue, and electrical leads and contact points

Depending on the material selection for the conductive fabric and the finishing material, the final laminate heater 20 of the present invention may be a soft, flexible and thin laminate fabric heater. Further, the laminate heaters 20 according to the present invention may be used in a wide variety of applications, including, for example the following applications: heating pads; medical blankets; food warming bags; thermal targets; tire warmers; personal warmers for shoes, ski boots, gloves, hats, jackets and the like; freeze protection for outdoor electronics and water pipes; food display cases; semiconductor test fixtures; battery pack heaters; incubators; seat heaters; steering wheel heaters; floor mat heaters; propeller and leading edge deicing systems for aircraft; defrost heaters; holding cabinets, table tops on which patients are positioned for muscle relaxation or for added warmth, such as after surgery; and hot plates to name a few.

### EXAMPLE 1

An exemplary laminate heater 20 according to the present invention was constructed. The heater 20 had the design shown in FIGS. 1 and 2. To form the fabric heating element 22 a carbon fiber fabric having a resistivity of 0.9 ohm per square, a thickness of 0.6 mm, and a weight of 260 g/m² was obtained in roll format. The roll had a width of 1230 mm. One side of the roll of carbon fiber fabric was laminated with a double sided PE laminated release paper having a thickness of 0.135±0.008 mm and a weight of 118±7 g/m². A double sided pressure sensitive adhesive was used to perform the lamination. The adhesive was acrylic based and had a thickness of 0.045±0.003 mm and a weight of 45±0.003 mm. Following lamination with the release paper, the roll laminated carbon fiber fabric was slit into smaller rolls, each having a width of 75 mm.

The final heater 20 to be formed according to this example was to have external dimensions of 123 mm×75 mm. Accordingly, a 123 mm length of the laminated carbon fiber fabric was cut from the 75 mm wide roll. A heating element 22 was then patterned in the shape shown in FIG. 4 using a standard punch press so as to fit within the provided area and to provide a heating element with a resistance of approximately 17 ohms. The punch was set up so that it would not cut through the release paper. After the carbon fiber fabric was patterned to have a patterned conductive fabric layer 39, the excess carbon fiber fabric was removed from the substrate, thus leaving only the patterned conductive fabric layer 39 on the substrate 72.

A conductive silver glue was then applied to the first and second ends 40, 42 to form regions 62, 64 of reduced conductivity. The conductive silver glue had a viscosity of 170 dPa. The maximum silver particle size in the glue was 3 μm, and the silver particle content in the glue was 72±2% by weight.

Electrical leads 28, 30 were then attached to the heating element so that their stripped ends abutted the conductive silver glue applied to regions 62, 64. A strip 44 of double sided tape was used to hold the electrical leads in place against the heating element 22. The electrical leads had an OD of 1.25±0.08 mm with a copper wire core. The lead wires had a PVC insulation jacket that was heat resistant to 105° C.

A first protective layer 24 was laminated on to the side of the heating element 22 opposite the release paper 72. The protective layer was 123 mm×75 mm in size, thus having the same size as release paper 72. This made it easy to properly align the heating element 22 to the first protective layer 24 prior to lamination. The protective layer had a weight of 210 g/m² and a thickness of 0.22 mm. Further, the protective layer was a laminate comprising a binding layer 50 of a hot melt adhesive film, a first inner finishing layer 52 of a polyurethane thermoplastic, and a second outer finishing layer of a 30 D micro fiber polyester fabric.

To laminate the protective layer 24 to the heating element 22, the protective layer was positioned over the heating element so that the hot melt adhesive side of the protective layer was facing the side of the heating element on which the electrical leads 28, 30 were attached. The protective layer 24 was aligned with the release paper, which in turn aligned the heating element with respect to the protective layer. The protective layer and heating element were then placed in a hot press with the protective layer on top, and hot pressing was carried out under the following conditions: pressure=5 Kg/m²; temperature=155° C.; and hot press time=20 sec. Following the lamination of the first protective layer 24, release paper 72 was stripped from the heating element 22. A second protective layer 26, identical to the first was then laminated to the other side of the heating element 22 using the same hot press parameters. Following the second lamination step the heating element was sandwiched between and encapsulated within the first and second protective layers.

In both lamination steps, the lamination parameters were set so as to melt the hot melt adhesive without melting either of the finishing layers.

The final laminate heater had exterior dimensions of 123 mm×75 mm and a total thickness of 0.9 mm. The resulting heater looked like the laminate fabric heater 22 of FIG. 1 and was soft, flexible, light weight, and water proof. The heating element had a total resistance of 17 ohms, and produced 4.15 watts of power from an 8.4 volt rechargeable Li-ion battery. A temperature controller 32 having a high temperature mode, medium temperature mode, and a low temperature mode was connected to electrical leads 28, 30. When the “High” temperature mode was selected by temperature adjustment means 36 of controller 32, the heating element was powered at a duty cycle equal to 75%. When the “Medium” temperature mode of controller 32 was selected, the heating element 22 of heater 20 was powered at a duty cycle equal to 50%. Finally, when the “Low” temperature mode was selected, the heating element 22 of heater 20 was powered at a duty cycle of 25%. Further, in the “High” temperature mode, the temperature of the heater was raised about 30° C. When the “Medium” temperature mode was selected, the temperature of the heater was raised about 25° C., but the battery lasted longer between recharges. Finally, when the “Low” temperature mode was selected, the temperature of the heater was raised about 20° C., but the battery lasted significantly longer than in either of the other two modes. The heater design according to the present example may be used in a variety of applications, including as a warmer in a jacket. Further, if desired, multiple heaters could be provided for a single jacket and all controlled by a single controller 32.

Although the invention has been described with reference to preferred embodiments and specific examples, it will readily be appreciated by those skilled in the art that many modifications and adaptations of the structures and methods described herein are possible without departure from the spirit and scope of the invention as claimed hereinafter. For example as noted above in the summary of the invention, the structures and processes of the present invention may readily be adapted for more general application to the field of laminating materials that are non-self-supporting. Thus, it is to be clearly understood that this description is made only by way of example and not as a limitation on the scope of the invention as claimed below.

1. A laminate fabric heater comprising:
a heating element, the heating element including a conductive fabric layer patterned to define an electrical circuit having first and second ends, and a contact adhesive layer adhered to a first side of the conductive fabric layer;
first and second electrical leads adjacent to and in electrical communication with a second side of the conductive fabric layer at the first and second ends, respectively; and
first and second protective layers disposed on opposing sides of the heating element to form a laminate with the heating element, wherein the heating element is sandwiched between the first and second protective layers so that the first and second electrical leads extend from the laminate.

2. The laminate fabric heater of claim 1, wherein the conductive fabric layer comprises a carbon fiber fabric.

3. The laminate fabric heater of claim 2, wherein the carbon fiber fabric is a woven fabric.

4. The laminate fabric heater of claim 3, wherein the carbon fiber fabric is woven from spun yarn.

5. The laminate fabric heater of claim 2, wherein the carbon fiber fabric is a non-woven fabric.

6. The laminate fabric heater of claim 2, wherein the carbon fiber fabric has a surface resistivity range of 0.1 ohms per square to 1000 ohms per square, a weight range from 5 grams per square meter to 700 grams per square meter, and a thickness range from 0.05 millimeter to 5.0 millimeter.

7. The laminate fabric heater of claim 1, wherein the conductive fabric layer is further patterned so that current is required to travel in a non-linear path to flow from the first end to the second end of the electrical circuit and to provide the electrical circuit with a desired resistance value.

8. The laminate fabric heater of claim 7, wherein the conductive fabric layer is further patterned to meet shape limitations on the laminate fabric heater.

9. The laminate fabric heater of claim 7, wherein the conductive fabric layer is further patterned so that the electrical circuit has a serpentine or zig-zag shape.

10. The laminate fabric heater of claim 1, wherein the conductive fabric layer comprises a conductive fabric selected from the group consisting of metal fabric, metal fiber fabric, graphite fiber fabric and carbon fiber fabric.

11. The laminate fabric heater of claim 1, wherein the heating element further includes conductive glue disposed on a second side of the conductive fabric layer, opposite the first, at the first and second ends so as to form areas of reduced resistivity extending across the width of the conductive fabric layer at the first and second ends.

12. The laminate fabric heater of claim 11, wherein the first and second electrical leads abut the conductive glue disposed at the first and second ends of the electrical circuit.

13. The laminate fabric heater of claim 12, wherein the heating element further includes conductive glue disposed at one or more regions between the first and second ends.

14. The laminate fabric heater of claim 1, wherein the first and second protective layers each comprise a thermoplastic or a hot melt adhesive.

15. The laminate fabric heater of claim 14, wherein the first and second protective layers each comprise a thermoplastic.

16. The laminate fabric heater of claim 1, wherein the first and second protective layers each comprise a laminate including a binding layer and one or more finishing layers.

17. The laminate fabric heater of claim 16, wherein the binding layer comprises a thermoplastic or a hot melt adhesive.

18. The laminate fabric heater of claim 17, wherein the one or more finishing layers comprise at least one material selected from the group consisting of fabric, foam, rubber, plastic sheets, glass, wood, and metal.

19. The laminate fabric heater of claim 11, wherein the patterned conductive fabric is patterned to have a zig-zag shape that includes at least two parallel strips, wherein each pair of parallel strips is attached at one end, and wherein the patterned conductive fabric includes a region of reduced resistivity at each of the connected ends of the strips that is formed through the application of conductive glue to the region.

20. The laminate fabric heater of claim 19, wherein the strips are cut to a desired length and width based on power requirements.

21. The laminate fabric heater of claim 1, wherein the first and second protective layers cooperate to encapsulate the heating element.

22. A laminate fabric heater comprising:
a heating element, the heating element including a conductive fabric layer patterned to define an electrical circuit having first and second ends and a non-linear path therebetween, and conductive glue disposed on a first side of the conductive fabric layer at the first and second ends to form areas of reduced resistivity extending across the width of the electrical circuit at the first and second ends;
first and second electrical leads attached to the conductive fabric layer at the first and second ends, respectively, so that the first and second electrical leads are abutting the conductive glue disposed at the first and second ends, respectively; and
first and second protective layers disposed on opposing sides of the heating element to form a laminate with the heating element, wherein the heating element is sandwiched between the first and second protective layers so that the first and second electrical leads extend from the laminate.

23. The laminate fabric heater of claim 22, wherein the conductive fabric layer is further patterned to meet resistance or shape requirements of the laminate fabric heater.

24. The laminate fabric heater of claim 23, wherein the conductive fabric layer is further patterned so that the electrical circuit has a serpentine shape between the first and second ends of the circuit, and the electrical resistivity of the circuit is substantially constant between the first and second ends.

25. The laminate fabric heater of claim 23, wherein the conductive fabric is further patterned to have a zig-zag shape that includes at least two parallel strips between the first and second ends, wherein each pair of parallel strips are attached at one end, and wherein the heating element further includes conductive glue disposed on the first side of the patterned conductive fabric at each of the attached ends of the strips to form regions of reduced resistivity thereat.

26. The laminate fabric heater of claim 22, wherein the first and second protective layers cooperate to encapsulate the heating element.

27-54. (canceled)

55. A laminate comprising:
a patterned layer having first and second sides, the first side of the patterned layer comprising a patterned non-self-supporting material, the second side of the patterned layer comprising a contact adhesive layer adhered to the non-self-supporting material;
first and second protective layers disposed on the first and second sides of the patterned layer to form a laminate with the patterned layer, wherein the patterned layer is sandwiched between the first and second protective layers.

56. (canceled)
